(19) United States
(12) Patent Application Publication
(10) Pub. No.: US 2025/0356058 A1
(43) Pub. Date: Nov. 20, 2025

(54) VERIFICATION OF ACCEPTANCE OF DATA SHARED AMONG PLURALITY OF NODES

(71) Applicant: TRAENT S.R.L., Milano (IT)

(72) Inventors: Federico D'Annunzio, Piazzale Galileo 2, Firenze (IT); Fabio Severino, Piazza Cairoli 3, PISA (IT); Andrea Canciani, Via delle Medaglie d'oro 13, PISA (IT); Claudio Felicioli, Via Giuseppe Cesare Abba 4, PISA (IT)

(73) Assignee: TRAENT S.R.L., Milano (IT)

(21) Appl. No.: 18/869,562

(22) PCT Filed: May 29, 2023
(86) PCT No.: PCT/EP2023/064323

§ 371 Date: Nov. 26, 2024

(30) Foreign Application Priority Data
May 30, 2022 (IT) 102022000011378

(51) Int. Cl. G06F 21/64

(52) U.S. Cl. CPC G06F 21/64

(57) ABSTRACT

A solution is proposed. The solution is performed under the control of a computing system (1051, 1052, 115, 125). The solution comprises allowing (4051, 4052) a first node (1051) and a second node (1052) of the computing system to participate to a private ledger (110) adapted to take a plurality of versions over time each resulting from appending one or more blocks thereto. The solution comprises appending (410) a first one of the blocks to the private ledger by the first node, the first block being authenticated by the first node and comprising data to be shared with the second node. The solution comprises appending (425) a second one of the blocks to the private ledger by the second node, the second block being authenticated by the second node and comprising an acknowledgement indicative of an acceptance of the data of the first block by the second node according to one or more policies defining a semantic of the acceptance. The solution comprises storing corresponding digests for the versions of the private ledger into a persistent storage, the digest of each of the versions being representative of the appending of the corresponding blocks of the version. The solution comprises disclosing verification information and the policies to an auditing node not participating to the private ledger in response to a verification request. The verification information may comprise a last one of the versions of the ledger. Alternatively, the verification information may comprise a ledger portion comprising the data and the acknowledgement, and corresponding inclusion proofs of the ledger portion in the versions of the private ledger. Thus, the auditing node is allowed to verify the acceptance of the data by the second node according to the verification information, the policies and the digests retrieved from the persistent storage.

### TECHNICAL FIELD

The present disclosure relates to the information technology field. Particularly, the present disclosure relates to distributed ledger technology.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Storing of data is a commonplace activity in most computing systems (for example, for their preservation, outputting, and/or further processing). In several situations, the storing of data is subject to specific requirements.

Particularly, it may be required that the storing of the data is persistent; this means that it should not be possible to remove the data once they have been stored; therefore, any updates of the data should preserve all previous versions of the same data. For this purpose, it may be important to ensure integrity of the data being stored.

Distributed ledger technology (DLT) is a technology used to maintain a distributed ledger, i.e. a replicated, shared, and synchronized collection of digital records spread across multiple computer nodes (also referred to as “participant nodes” or simply “nodes”) typically located across multiple sites, countries, or institutions.

All information in the ledger typically uses cryptography techniques to ensure consistency, integrity, security and permissions using cryptographic keys, encryption and digital signatures.

A conventional distributed ledger stores data into a sequence of data blocks in chronological order, linked to each other via corresponding hash values. The ledger is distributed throughout the participant nodes, which validate its content according to a consensus schema. In a consensus schema based on a proof of work, a complex mathematical problem has to be solved by determining a nonce to be added to each data block that provides a specific property of its hash value. Therefore, no data block may be altered without re-determining the nonces of such data block and of all the next data blocks in the ledger; however, the difficulty of the mathematical problem required to determine the nonces makes substantially impossible to alter the distributed ledger (unless a majority of the processing power of the whole network is acquired).

Distributed ledger technology has been initially designed to work with financial data, and the typical data block design is essentially a container for a list of small financial transactions.

More recently, distributed ledger technology is used in fields different than financial field (such as the internet of things, supply chains of various commodities, sharing of secure data, and logistic monitoring), and has great potential to revolutionize the way organizations operate in many industry verticals.

According to the Applicant, a very interesting field to which distributed ledger technology may find application is supply chain, and particularly supply chain traceability, i.e., the process of tracking the provenance and journey of products and their inputs, from the very start of the supply chain through to end-use. Indeed, with the rise in the ‘ethical economy’ and the changing consumer behaviors, consumers are increasingly concerned about the ethics of their choices and product provenance. As such, consumers may want to know about aspects or topics of the supply chain through which a product was purchased or is intended to be purchased.

An example of aspect or topic of the supply chain for which traceability of products is increasingly desired, is supply chain sustainability, i.e. the environmental and human impact of products through the supply chain, from raw materials sourcing to production, storage, delivery and transportation link(s) in between. For instance, consumers may want to know if the production of products harms the environment, and/or if it is based on child labor, and/or if it causes harm to individuals in developing countries, and/or if it endangers plant or animal species.

Another example of aspect or topic of the supply chain for which traceability of products is increasingly desired, is supply chain product provenance or quality added value. For instance, consumers may want to know if a food product has been obtained from non-GMO and/or GMO-free seeds.

Today, supply chain traceability is not practically possible, due to lack of data capture, concerns over data privacy, and difficulties of managing inter-actor cooperation in the supply chain.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In its general terms, the present disclosure is based on the idea of, in the context of data sharing among first and second nodes participating to a private ledger, notarizing the data and data acknowledgements indicative of an acceptance of the data according to one or more policies, so as to allow independent verification of the acceptance by an auding node not participating to the private ledger.

Particularly, an aspect of the solution according to embodiments of the present disclosure provides a method comprising the following steps. First and second blocks are appended to the private ledger by the first and second nodes, respectively, wherein the first block comprises the data to be shared and the second block comprises the data acknowledgement indicative of the acceptance of the data by the second node.

Corresponding digests for versions of the private ledger are stored into a persistent storage. Verification information and the policies are disclosed to an auditing node not participating to the private ledger, the verification information comprising either a last one of the versions of the ledger, or a ledger portion comprising the data and the data acknowledgement, and corresponding inclusion proofs of the ledger portion in the versions of the private ledger.

Another aspect of the solution according to embodiments of the present disclosure provides a software program (or computer program) for implementing the method.

A further aspect of the solution according to embodiments of the present disclosure provides a corresponding software program product (or computer program product).

A further aspect of the solution according to embodiments of the present disclosure provides one or more computing systems for implementing the method.

More specifically, one or more aspects of the solution according to embodiments of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution according to embodiments of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each participant node is generally used to denote both its type and its attributes, like value, content and representation). Particularly:

FIG. 1A to FIG. 1E show the general principles of the solution according to embodiments of the present disclosure;

FIG. 2 shows a schematic block diagram of an information technology infrastructure that may be used to implement the solution according to embodiments of the present disclosure;

FIG. 3 shows the main software components that may be used to implement the solution according to embodiments of the present disclosure, and

FIG. 4A and FIG. 4B show an activity diagram describing the flow of activities relating to an implementation of the solution according to embodiments of the present disclosure.

### DETAILED DESCRIPTION

In the following, when one or more features are introduced by the wording “according to an embodiment”, they are to be construed as features additional or alternative to any features previously introduced, unless otherwise indicated and/or unless there is evident incompatibility among feature combinations.

In the following, only relevant features that are deemed pertinent for the understanding of the present disclosure will be discussed, with well-known and/or obvious variants of the relevant features that will be omitted or briefly mentioned for the sake of conciseness.

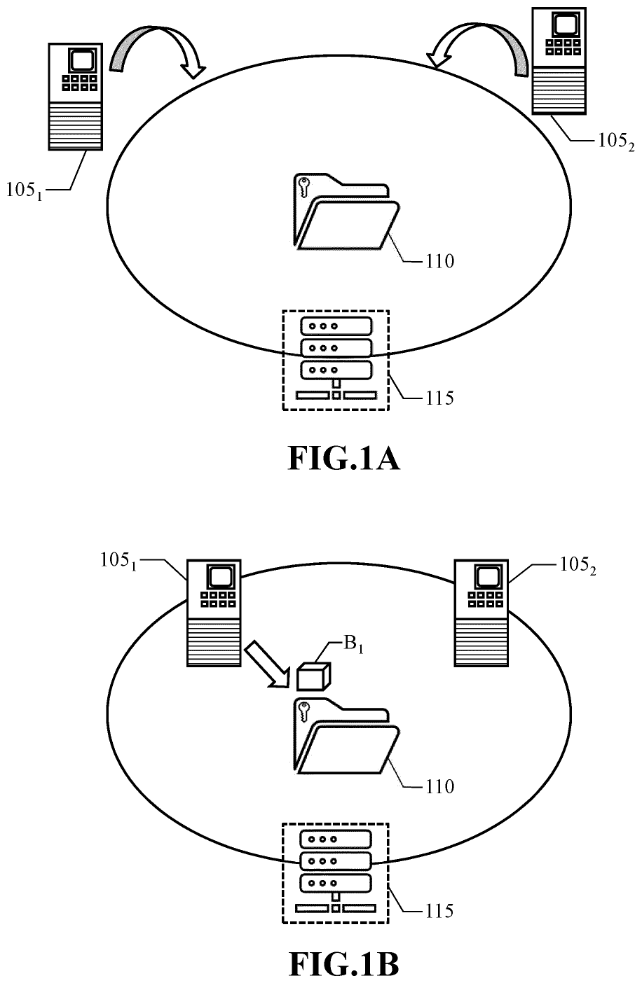

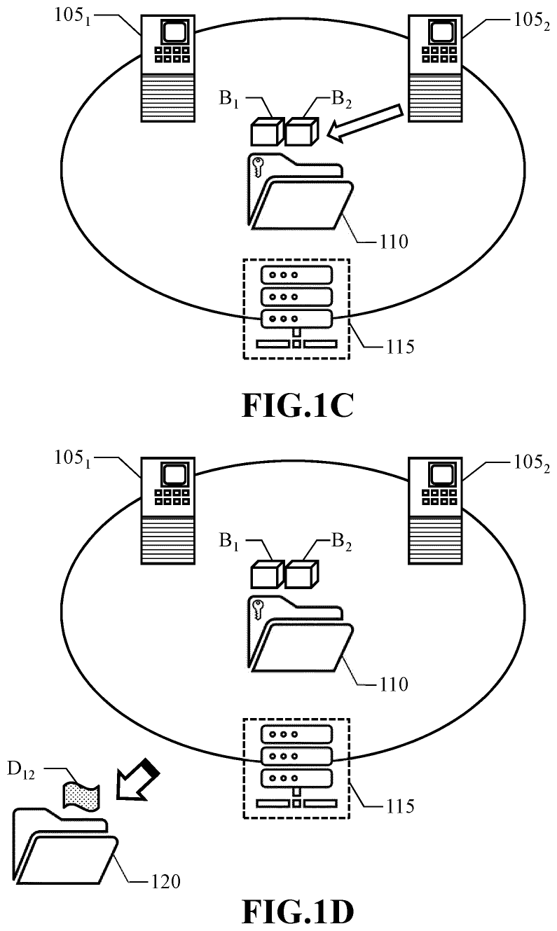

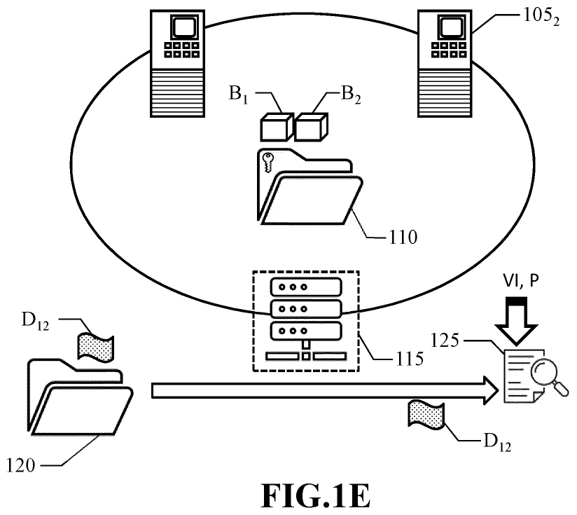

With reference to FIG. 1A-FIG. 1E, they show the general principles of the solution according to embodiments of the present disclosure.

According to an embodiment, the solution according to embodiments of the present disclosure is implemented by (or under the control of) a computing system, i.e., a system comprising a plurality of apparatuses having processing capabilities.

Starting from FIG. 1A, a first node (hereinafter, first participant node) 105₁ and a second node (hereinafter, second participant node) 105₂ of the computing system are allowed to participate to (i.e., join) a private ledger 110, for example on a private network.

Without losing generality, the first 105₁ and second 105₂ participant nodes comprise respective companies or organizations in a partnership relationship to each other, the first 105₁ and second 105₂ participant nodes being for example in commercial or business partnership relationship to each other.

Just as a practical example, the first 105₁ and second 105₂ participant nodes may comprise respective actors or players of a supply chain, such as a supplier of raw material such as steel, oil, corn, grain, seeds, gasoline, lumber, forest resources, plastic, and minerals (material supplier), and a manufacturer of respective finished products or semi-finished products (product manufacturer).

Without losing generality, depending on the specific implementation, a plurality of first participant nodes and/or a plurality of second participant nodes may be provided. Just as a practical use case scenario, a single product manufacturer and a plurality of material suppliers supplying the product manufacturer with a raw material or with respective raw materials may be provided.

For the purposes of the present disclosure, the private ledger 110 is a ledger with access permissions restricted to the nodes of the computing system allowed to participate to the private ledger 110 (such as the first 105₁ and second 105₂ participant nodes).

The private ledger 110 is adapted to take a plurality of versions over time (hereinafter, ledger versions) each one resulting from appending one or more blocks thereto. According to an embodiment, the blocks are arranged in the private ledger 110 in (chronological) sequence defined by their appending to the private ledger 110. For this purpose, the blocks may only be added in sequence by appending them to an end of the private ledger 110. Therefore, the private ledger 110 accumulates the blocks that are never removed from the private ledger 110 once they have been added therein (with any updates of the block that preserve all previous versions of the same block).

According to an embodiment, the private ledger 110 comprises a private distributed ledger, i.e., a data structure in which each participant node (such as the first 105₁ and second 105₂ participant nodes) maintains and updates a respective copy of the private ledger 110, or ledger copy (which results in eventually consistent ledger copies across the participant nodes of the private network). According to an embodiment, each participant node stores the respective ledger copy in a respective repository. Without losing generality, the repository of each participant node may be physically located or reside in that participant node or may be physically located or reside remotely with respect to that participant node.

Without losing generality, nodes of the computing system may be allowed to participate to the private ledger 110 based on a private agreement, and/or by permission from a manager of the private ledger 110 and/or of the private network.

As conceptually represented in the figure by a dashed box, a certification node 115 of the computing system may optionally be provided. Just as an example, the certification node 115 may be the manager of the private ledger 110 and/or of the private network.

For the purposes of the present disclosure, the certification node 115 may comprise an entity in charge of evaluating the consistency of a history of the private ledger 110 (hereinafter, ledger history), for example the absence of forks.

According to an embodiment, the evaluation of the consistency of the ledger history may be performed by the certification node 115 by means of one or more technical implementations which are not limiting for the present disclosure.

According to an embodiment, the evaluation of the consistency of the ledger history may be performed by the certification node 115 acting as a generally trusted authority being trusted by (e.g., by convention among) the participant nodes (such as the first participant node 105₁ and the second participant node 105₂).

Moving to FIG. 1B, the first participant node 105₁ shares data with the second participant node 105₂. In order to achieve it, the first participant node 105₁ appends, to the private ledger 110, a first block B comprising the data to be shared with the second participant node 105₂.

In a practical implementation, the data may comprise data relating to a topic. According to an embodiment, the data may comprise (but is not limited to) one or more among logs, documents, transactions, certifications and chats relating to the topic.

Examples of topics include, but are not limited to, supply chain sustainability (for instance, the exclusive use of recycled materials in case of a packer as an example of material supplier), and supply chain product provenance or added value (for instance, the use of non-GMO and/or GMO-free seeds in case of a food manufacturer as an example of material supplier, or the use of organic farming practices in case of a farmer as an example of material supplier).

Just as a practical, non-limiting example, the data may comprise a respective document or certificate or written declaration from one or more nonprofit organizations attesting the use of non-GMO and/or GMO-free seeds.

According to an embodiment, the first block B₁ (or the corresponding data to be shared) is authenticated by the first participant node 105₁. Without losing generality, authentication of the first block B₁ (or of the corresponding data to be shared) may be achieved by any proper proof allowing to verify that the first block B₁ (or the corresponding data to be shared) was produced and appended by the first participant node 105₁.

Moving to FIG. 1C, the second participant node 105₂ appends a second block B₂ to the private ledger 110. According to an embodiment, the second block B₂ comprises an acknowledgement (or data acknowledgement) indicative of an acceptance, by the second participant node 105₂, of the data of the first block B₁.

According to an embodiment, the data and/or the data acknowledgment have to be compliant with one or more policies (hereinafter, data/acknowledgement policies).

According to an embodiment, the data/acknowledgement policies define a format of the data (hereinafter, data format) and the corresponding format of the data acknowledgment (hereinafter, acknowledgment format), for example in order to be able to determine a formal correctness of the data and of the data acknowledgment (as better discussed in the following).

Examples of data and acknowledgement formats defined by the data/acknowledgement policies include, but are not limited to, maximum size of files and/or fields and/or strings and/or parameters, presence of optional files and/or fields and/or strings and/or parameters, presence of mandatory files and/or fields and/or strings and/or parameters, presence and/or number of signatures, signature and/or encryption criteria, and admitted and/or non admitted file types (e.g., image, pdf, ZIP file types).

According to an embodiment, the data/acknowledgement policies define a semantic of the acceptance of data shared between the nodes participating to the private ledger 110 (or, otherwise stated, the semantic of the data acknowledgement), for example in order to be able to determine a meaning of the data acknowledgement (as better discussed in the following).

According to an embodiment, the data/acknowledgement policies (or at least a subset thereof) may be contained in the private ledger 110 (for example, in a first or genesis block thereof). Without losing generality, the data/acknowledgement policies (or at least a subset thereof) may be contained or stored in local or remote storage or processing entities of the computing system or of a corresponding infrastructure (discussed in the following), the data/acknowledgement policies being therefore stored separately from the private ledger 110. Just as an example, the data/acknowledgement policies may be stored at any storage or processing entity of (i.e., associated with and/or communicably coupled with) the first participant node 105₁, the second participant node 105₂, and/or the certification node 115.

According to an embodiment, the second block B₂ (or the corresponding data acknowledgement) is authenticated by the second participant node 105₂. Without losing generality, authentication of the second block B₂ (or of the corresponding data acknowledgement) may be achieved by any proper proof allowing to verify that the second block B₂ (or the corresponding data acknowledgement) was produced and appended by the second participant node 105₂.

Moving to FIG. 1D, digests for the ledger versions are stored into a persistent data structure. Without losing generality, the persistent data structure may comprise a tamper-proof data structure.

By tamper-proof storage it is herein meant a storage configured to make practically unfeasible altering its stored content. This means that an altering of the stored content would require an effort higher than an importance thereof. Therefore, even if someone with enough resources (such as available time, computational power, skill, knowledge and/or instruments) might potentially manage to alter the stored content, the need to resort to these extreme measures (and a possible uncertainty of the obtained results) is a significant deterrent in practical circumstances; this frustrates any attempt of altering the stored content down to deter everybody from attempting it, thereby effectively preventing doing so.

According to an embodiment, the persistent data structure comprises a public blockchain 120 (i.e., a publicly accessible blockchain). The digest of each ledger version is representative of the appending of the corresponding blocks of the ledger version. In the illustrated example of FIG. 1D, the digest D₁₂ represents the digest of the ledger version resulting from appending of the first B₁ and second B₂ blocks (although this should not be construed limitatively).

According to an embodiment, digest computation and/or storing (such as computation and/or storing of the digest D₁₂) may be performed by the first participant node 105₁, by the second participant node 105₂, and/or by the certification node 115 (when provided).

According to an embodiment, computation and storing of the digest(s) of the ledger version(s) resulting from appending of the first data block B₁, which contains the data, and of the second data block B₂, which contains the corresponding data acknowledgement, results in a content notarization.

Moving to FIG. 1E, the acceptance of the data by the second participant node 105₂ is allowed to be verified by an auditing node 125 not participating (i.e., having no access) to the private ledger 110 (and, hence external to the private network), for example in response to a corresponding verification request.

According to an embodiment, verification information and the acknowledgement policies are disclosed to the auditing node 125 in response to the verification request.

According to an embodiment, the verification information comprises a last one of the versions of the private ledger 110 (hereinafter, last ledger version).

According to an alternative embodiment, the verification information comprises a ledger portion comprising the data and the data acknowledgement, and corresponding inclusion proofs of the ledger portion proving the inclusion of the ledger portion in the versions of the private ledger 110. For the purposes of the present disclosure, an inclusion proof is a proof that cryptographically demonstrates that the ledger portion is included in the private ledger 110 without exposing a whole content thereof. Without losing generality, the inclusion proofs may comprise Merkle inclusion proofs.

According to an embodiment, the auding node 125 is allowed to verify the acceptance of the data by the second participant node 105₂ according to the verification information (denoted by VI in the figure), the policies (denoted by P in the figure) and the digests retrieved from the public blockchain 120 (such as the digest D₁₂).

Therefore, the auditing node 125, which may for example be or act on behalf of a consumer (such as a purchaser or a potential purchaser of goods), is allowed to verify the truthfulness of the data relating to a topic shared by the first participant node 105₁ with the second participant node 105₂ by verifying the data itself and the respective data acknowledgement.

Data and data acknowledgement verifications may allow the proposed solution to find application in many fields, including supply chain, and particularly supply chain traceability. Indeed, the possibility of reliably verifying data and data acknowledgements may allow users to track the provenance and journey of products and their inputs, from the very start of the supply chain through to end-use. This is achieved in a quite simple way, and with a relatively low consumption of networking, computational and storage resources.

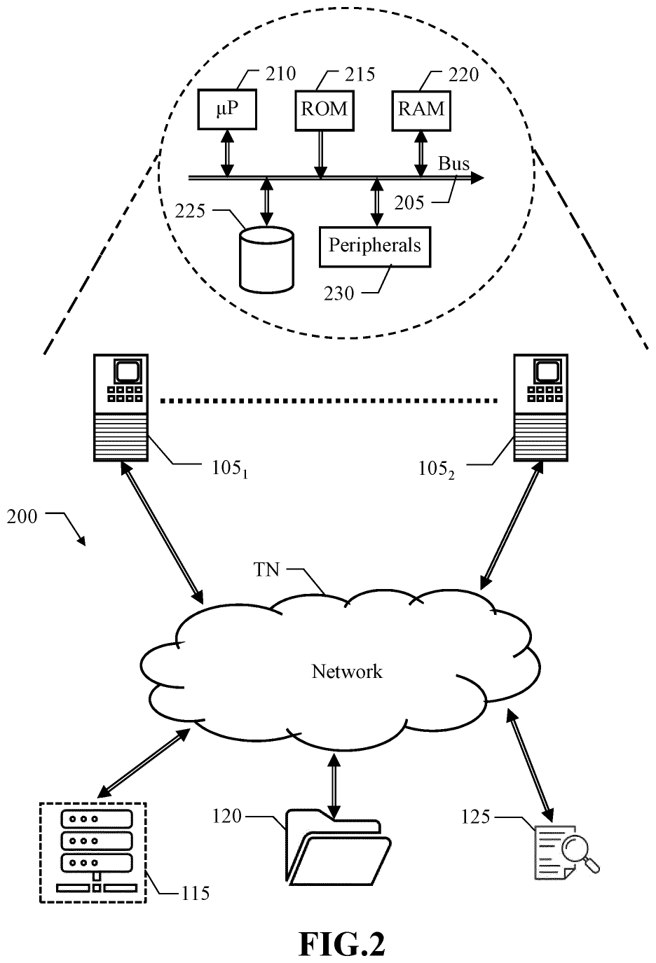

With reference now to FIG. 2, it shows, in terms of operating units, a schematic block diagram of an information technology infrastructure 200 (hereinafter concisely referred to as infrastructure) that may be used to implement the solution according to embodiments of the present disclosure.

According to an embodiment, the infrastructure 200 comprises a plurality of (i.e., two or more) nodes or participant nodes (for example, nodes in a commercial or business partnership relationship to each other). In the illustrated example, the infrastructure 200 comprises the first 105₁ and second 105₂ participant nodes.

According to an embodiment, the infrastructure 200 may comprise the certification node 115. As mentioned above, the certification node 115 is optional in basic embodiments of the present disclosure. According to an embodiment, the certification node 115 (when provided) is configured to perform content notarization.

In embodiments in which no certification node is provided, content notarization may be performed by different nodes of the computing systems, such as the first participation node 105₁ and/or the second participant node 105₂.

According to an embodiment, the infrastructure 200 comprises the public blockchain 120 (or more thereof). According to an embodiment, the public blockchain 120 is configured to store in a persistent and tamper-proof manner the digests associated with the ledger versions. According to an embodiment, the public blockchain 120 may be communicatively coupled to the first participant node 105₁, the second participant node 105₂, and the certification node 115 (when provided), so as to allow the first participant node 105₁, the second participant node 105₂, and the certification node 115 (when provided) to store the digests associated with the ledger versions.

According to an embodiment, the infrastructure 200 comprises one or more (e.g., a plurality of) auditing nodes, such as the auditing node 125. According to an embodiment, the auditing node 125 is configured to communicate with the first participant node 105₁, the second participant node 105₂, the public blockchain 120, and the certification node 115 (when provided). According to an embodiment, the auditing node 125 is configured to verify the acceptance of the data according to the verification information VI, the data/acknowledgement policies P, and the digests retrieved from the public blockchain 120.

According to an embodiment, the infrastructure 200 comprises a telecommunication network TN. According to an embodiment, the telecommunication network TN is configured to allow the first 105₁ and second 105₂ participant nodes, the certification node 115 (when provided), the public blockchain 120, and the auditing node 125 to communicate with each other. According to an embodiment, the telecommunication network TN comprises a wired telecommunication network and/or a wireless communication network. According to an embodiment, the telecommunication network TN implements a private network (e.g., whose access is restricted to the participant nodes, such as the first 105₁ and second 105₂ participant nodes), and a public network (such as a global telecommunication network based on the Internet) allowing the first participant node 105₁, the second participant node 105₂ the certification node 115 (when provided), and the auditing node 125 to communicate with each other, and/or to access the public blockchain 120.

According to an embodiment, the first 105₁ and second 105₂ participant nodes, the certification node 115, and the auditing node 125 identify, each one, a respective computing sub-system of the computing system (the computing system comprising, as a whole, the first 105₁ and second 105₂ participant nodes, the certification node 115, and the auditing node 125).

According to an embodiment, each computing sub-system comprises a plurality of devices that are connected to each other through a bus structure 205 at one or more levels (with an architecture that is suitably scaled according to the type of the computing system).

According to an embodiment, each computing sub-system comprises a microprocessor (μP) 210, or more thereof, providing a logic capability of the computing sub-system.

According to an embodiment, each computing sub-system comprises a non-volatile memory (ROM) 215 for storing basic code for a bootstrap of the computing sub-system.

According to an embodiment, each computing sub-system comprises a volatile memory (RAM) 220 used as a working memory by the microprocessor 210.

According to an embodiment, each computing sub-system comprises a mass-memory 225 for storing programs and data. Just as an example, the mass-memory 225 may comprise storage devices of a data center wherein the first 105₁ and second 105₂ participant nodes, the certification node 115 and the auditing node 125 are implemented.

According to an embodiment, each computing sub-system comprises a number of controllers for peripherals, or Input/Output (I/O) devices, 230. Just as an example, the peripherals 230 of the first 105₁ and second 105₂ participant nodes, the certification node 115 and the auditing node 125 (or of a subset thereof) may comprise a network adapter plugging them into the corresponding data center and then connecting them to a console of the data center for their control (for example, a personal computer, also provided with a drive for reading/writing removable storage devices, such as of USB type) and into a switch/router sub-system of the data center for their communication with the telecommunication network TN. Just as another example, the peripherals 230 of the first 105₁ and second 105₂ participant nodes, the certification node 115 and the auditing node 125 (or of a subset thereof) may comprise a keyboard, a mouse, a monitor, a network adapter for connecting to the telecommunication network TN and a drive for reading/writing removable storage devices (such as of USB type).

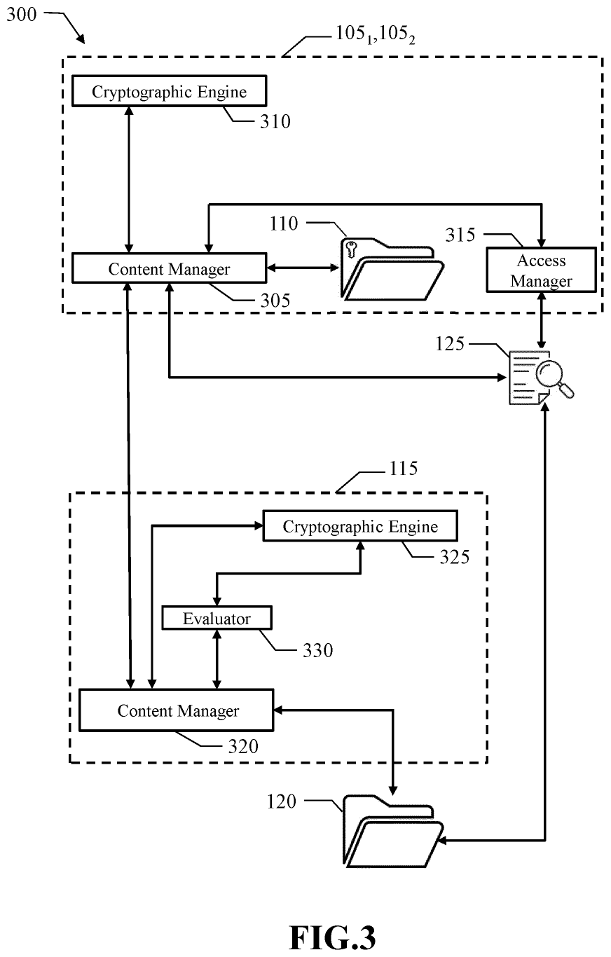

With reference now to FIG. 3, it shows the main software components that may be used to implement the solution according to embodiments of the present disclosure. Particularly, this figure shows the main software components 300 that may be used to implement a generic participant node (such as the first 105₁ and second 105₂ participant nodes) and the certification node 115 (when provided) according to embodiments of the present disclosure (in the following, the first 105₁ and second 105₂ participant nodes and the certification node 115 will be concisely referred to as nodes 105₁, 105₂, 115, when distinguishing among them is not relevant). For the sake of completeness, this figure also shows the private ledger 110, the public ledger 120, and the auditing node 125.

According to an embodiment, the software components 300 of each node 105₁, 105₂, 115 are stored in the respective mass memory and loaded (at least partially) into the respective working memory when the programs are running, e.g., together with an operating system and other application programs not directly relevant to the solution according to embodiments of the present disclosure (thus omitted in the figure for the sake of simplicity). The programs are initially installed into the mass memory, for example, from removable storage devices or from the telecommunication network. In this respect, each program may be a module, segment or portion of code, which comprises one or more executable instructions for implementing the specified logical function.

According to an embodiment, the software components 300 of the first 105₁ and second 105₂ participant nodes comprise a content manager 305. According to an embodiment, the content manager 305 is configured to manage processing, storing and/or transmission/reception of contents including, but not limited to, one or more among the data, the data acknowledgement, the first block, the second block, and the acknowledgement policies.

According to an embodiment, the content manager 305 is configured to interact with the private ledger 110, e.g., for block appending and/or for disclosing the private ledger 110 (for example, by exporting a copy) or a ledger portion (for example, by exporting a copy thereof).

According to an embodiment, the content manager 305 is configured to interact with the other participant nodes (e.g., with the respective content managers), and with the auditing node 125 (e.g., for transmission of one or more of the contents).

According to an embodiment, the content manager 305 is further configured to manage appending of blocks.

According to an embodiment, not shown, the content manager 305 is configured to interact with the public blockchain 120, so as to store the digests of the ledger versions therein (e.g., when the first participant node 105₁ and/or the second participant node 105₂ are in charge or responsible of content notarization).

According to an embodiment, the content manager 305 is configured to transmit the digests of the ledger versions to the certification node 115 (e.g., when the certification node 105₁ is provided, and when the certification node 115 is in charge or responsible of content notarization).

According to an embodiment, the software components 300 of the first 105₁ and second 105₂ participant nodes comprise a cryptographic engine 310 configured to implement cryptography operations.

According to an embodiment, the cryptographic engine 310 is configured to encrypt (with one or more corresponding encryption keys) one or more contents among the data, the data acknowledgement, the blocks, and the data/acknowledgement policies.

According to an embodiment, the cryptographic engine 310 is configured to apply a cryptographic signature of (or associated with) the respective participant node 105₁, 105₂.

According to an embodiment, the cryptographic engine 310 is configured to compute the digests associated with the ledger versions.

According to an embodiment, the cryptographic engine 310 is configured to compute, for each ledger portion to be disclosed to an auditing node (such as the auditing node 125), corresponding inclusion proofs proving the inclusion of the ledger portion in the versions of the private ledger 110.

According to an embodiment, the cryptographic engine 310 is configured to interact with the content manager 305.

According to an embodiment, the software components 300 of the first 105₁ and second 105₂ participant nodes comprise an access manager 315. According to an embodiment, the access manager 315 is configured to manage access to the private ledger 110 by the content manager 305 according to the verification request from the auditing node 125. According to an embodiment, the access manager 315 is configured to interact with the auditing node 125 to receive the verification request. According to an embodiment, the access manager 315 is configured to interact with the content manager 305 to cause it to retrieve or export the (complete) private ledger 110 (e.g., a complete copy thereof), or a ledger portion comprising the data and the data acknowledgement (if the data acknowledgement is provided) according to or meeting the verification request.

According to an embodiment, the software components 300 of the certification node 115 comprise a content manager 320. According to an embodiment, the content manager 320 is configured to interact with the content manager 305 to receive the digests of the ledger versions. According to an embodiment, the content manager 320 is configured to interact with the public blockchain 120 to store the digests therein (and/or, in embodiments of the present disclosure, to retrieve the digest stored therein on behalf of the auditing node 125).

According to an embodiment, the software components 300 of the certification node 115 comprise a cryptographic engine 325. According to an embodiment, the cryptographic engine 325 is conceptually analogous to the cryptographic engine 310. According to an embodiment, the cryptographic engine 325 is configured to interact with the content manager 320 (e.g., so as to sign the digests with cryptographic signatures of the certification node 115).

According to an embodiment, the software components 300 of the certification node 115 comprise an evaluator 330 for evaluating the consistency of the ledger history. According to an embodiment, the evaluator 330 is configured to interact with the content manager 320 (e.g., so as to evaluate the ledger history based on the digests). According to an embodiment, the evaluator 330 is configured to interact with the cryptographic engine 325 (e.g., so as to be supported by it, when necessary, with cryptographic operations).

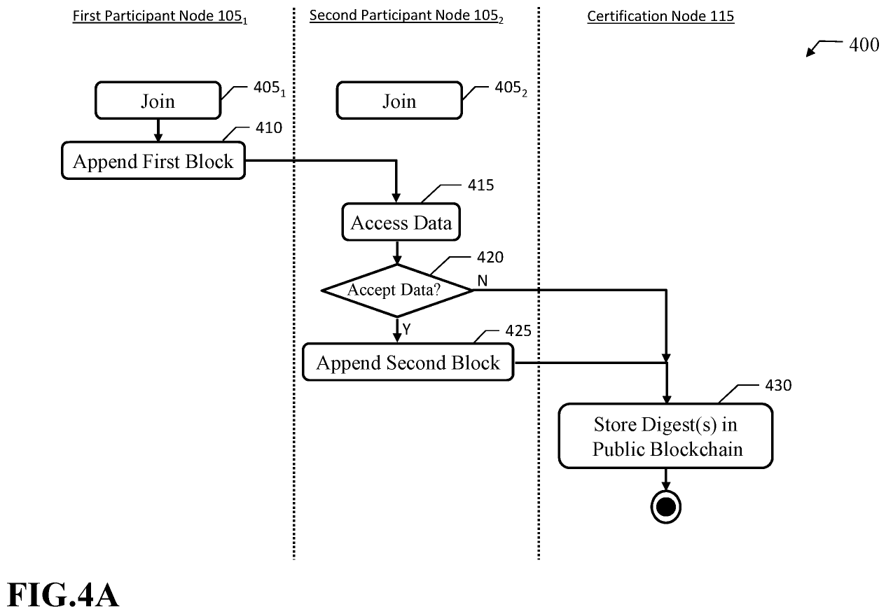

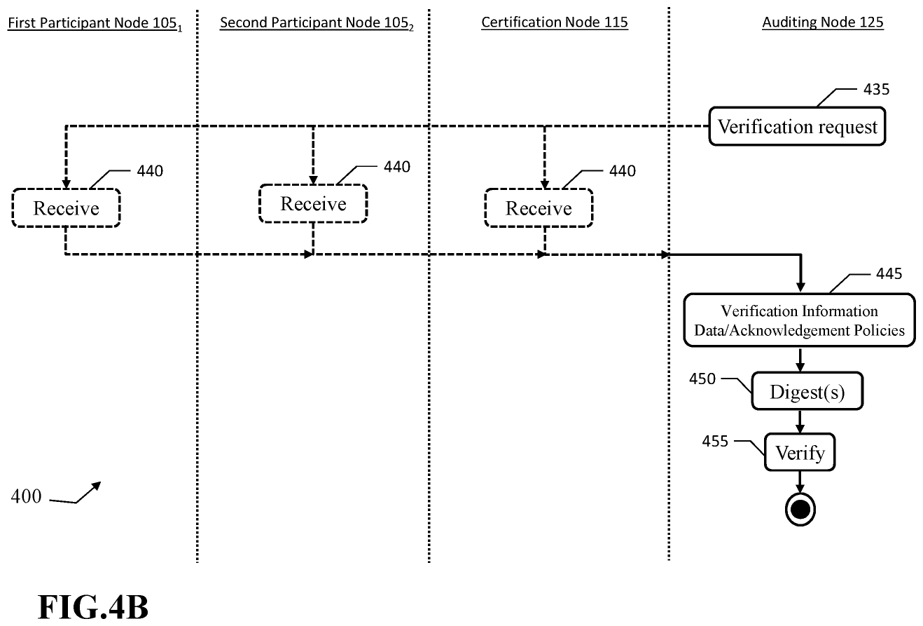

With reference now to FIG. 4A and FIG. 4B, they show a swim-lane activity diagram which describes the flow of activities relating to an implementation of the solution according to embodiments of the present disclosure. Particularly, the activity diagram represents an exemplary process or method 400 that may for example be used to verify acceptance of data. More particularly, the activity diagram represents an appending/notarization phase (FIG. 4A) and an auditing phase (FIG. 4B) of same contents (it being understood the that the auditing phase of contents may take place at any time instant after the appending/notarization phase of the same contents).

In this respect, each node of the activity diagram may correspond to one or more executable instructions for implementing the specified logical function on the relevant software component of a respective actor—i.e., in the exemplary considered embodiment, the first participant node 105₁, the second participant node 105₂ and the certification node 115 for the appending/notarization phase (FIG. 4A), and the first participant node 105₁, the second participant node 105₂, the certification node 115, and the auditing node 125 for the auditing phase (FIG. 4B).

Reference will be now made to the appending/notarization phase of the method 400 represented by the activity diagram of FIG. 4A.

According to an embodiment, the method 400 comprises allowing the first participant node 105₁ and the second participant node 105₂ to participate (or join, or being admitted) to the private ledger 110 (action nodes 405₁,405₂). As should be understood, participation (or joining or admission) may take place at respective times, which may be correlated or uncorrelated from each other.

According to an embodiment, the first 105₁ and second 105₂ participant nodes are allowed to participate to the private ledger 110 based on a (e.g., private) agreement (hereinafter, participation agreement).

According to an embodiment, the first 105₁ and second 105₂ participant nodes are allowed to participate to the private ledger 110 by permission from entities or nodes internal or external to the private network and/or participating or not participating to the private ledger 110.

Just as an example, the first 105₁ and second 105₂ participant nodes are allowed to participate to the private ledger 110 by permission from the certification node 115.

Just as another example, the first 105₁ and second 105₂ participant nodes are allowed to participate to the private ledger 110 by permission from the manager of the private ledger 110 and/or of the private network. According to embodiments, the certification node 115 may be the manager of the private ledger 110 and/or of the private network. According to an embodiment, the participation agreement and/or the permission may comprise and/or be based on and/or be conditioned to an agreement between the first 105₁ and second 105₂ participant nodes concerning the data/acknowledgement policies (hereinafter, policy agreement).

Without losing generality, the participation agreement and/or the permission may comprise and/or be based on and/or be conditioned to an agreement between the first 105₁ and second 105₂ participant nodes concerning one or more additional policies associated with the private ledger 110 (hereinafter, ledger policies). Examples of ledger policies include, but are not limited to, rules for admissions of new participant nodes to the private ledger and/or for interactions with or among the participant nodes, one or more criteria for policy update, and one or more criteria for block signature and/or encryption.

In the following, whenever the policy agreement is mentioned, the corresponding feature(s) or method step(s) equivalently apply in embodiments in which both the policy agreement and the agreement concerning the ledger policy or policies are considered.

According to an embodiment, the policy agreement is contained in the private ledger 110 (for example, in a first or genesis block thereof). Without losing generality, the policy agreement may be contained or stored in local or remote storage or processing entities of the computing system or of the infrastructure (the policy agreement being therefore stored separately from the private ledger 110). Just as an example, the policy agreement may be stored at any storage or processing entity of (i.e., associated with and/or communicably coupled with) the first participant node 105₁, the second participant node 105₂, and/or the certification node 115.

According to an embodiment, the policy agreement may be in encrypted form (or, otherwise stated, it may be or represent a respective encrypted content). According to an embodiment, the policy agreement may be encrypted by means of an encryption key associated with the entity or node having proposed or submitted the policy agreement.

According to an alternative embodiment, the policy agreement may be in plaintext or unencrypted form.

According to an embodiment, the method 400 comprises, at the first participant node 105₁, appending a first block to the private ledger 110 comprising the data to be shared with the second participant node 105₂ (action node 410).

According to an embodiment, the data may be in encrypted form (or, otherwise stated, the data may be or represent a respective encrypted content).

According to an alternative embodiment, the data may be in plaintext or unencrypted form.

According to an embodiment, the data may be in encrypted form or in unencrypted form depending on the ledger policies.

According to an embodiment, the first block may be in encrypted form (or, otherwise stated, the data may be or represent a respective encrypted content).

According to an alternative embodiment, the first block may be in plaintext or unencrypted form.

According to an embodiment, the first block may be in encrypted form or in unencrypted form depending on the ledger policies.

According to an embodiment, encryption of the data and/or of the first block may be determined by the cryptographic engine 310 of the first participant node 105₁ (e.g., under the control of the respective content manager 305).

According to an embodiment, the first block (or the corresponding data) is authenticated by the first participant node 105₁. According to an embodiment, the first block (or the corresponding data) is authenticated by a cryptographic signature of (or associated with) the first participant node 105₁.

According to an embodiment, the cryptographic signature of (or associated with) the first participant node 105₁ is performed by applying (by the first participant node 105₁) a cryptographic key of (or associated with) the first participant node 105₁ to the first block (or to the corresponding data).

According to an embodiment, the cryptographic key of (or associated with) the first participant node 105₁ is managed by a public key infrastructure (hereinafter, PKI infrastructure), not shown. According to an embodiment, the PKI infrastructure is managed by the certification node 115.

According to an embodiment, the cryptographic signature of (or associated with) the first participant node 105₁ is performed by the cryptographic engine 310 of the first participant node 105₁ (e.g., under the control of the respective content manager 305). Without losing generality, the cryptographic signature of (or associated with) the first participant node 105₁ may be performed by a dedicated signing engine of the first participant node 105₁ (not shown).

In alternative embodiments, the cryptographic signature of (or associated with) the first participant node 105₁ may be omitted (for example, when authentication of the first block, or of any block appended by the first participant node 105₁, is differently implemented).

According to an embodiment, the method 400 comprises, at the second participant node 105₂, accessing the data of the first block (action node 415), and, in case of acceptance of the data of the first block (exit branch Y of decision node 420), appending (to the private ledger 110) a second block comprising the data acknowledgement (action node 425).

According to an embodiment, the second block is subsequent to (i.e., it follows) the first block. As should be understood, the second block is not necessarily immediately subsequent to (i.e., it does not necessarily immediately follow) the first block.

As discussed above, the data acknowledgement is indicative of the acceptance of the data of the first block by the second participant node 105₂.

According to an embodiment, the data acknowledgement may directly refer (i.e., may have a direct reference) to the accepted data.

According to an alternative embodiment, the data acknowledgement may indirectly refer (i.e., may have an indirect reference) to the accepted data. Just as an example, the data acknowledgement may refer to data that hierarchically contains the accepted data. Just as another example, the data acknowledgement may refer to the (whole) first block. Just as a further example, the data acknowledgement may refer to a point of the private ledger subsequent to the first block (e.g., if the data/acknowledgement policies and/or the ledger policies allow it).

According to an embodiment, the acknowledgement data may be in encrypted form (or, otherwise stated, the acknowledgement data may be or represent a respective encrypted content).

According to an alternative embodiment, the acknowledgement data may be in plaintext or unencrypted form.

According to an embodiment, the acknowledgement data may be in encrypted form or in unencrypted form depending on the data/acknowledgement policies and/or the ledger policies.

According to an embodiment, the second block may be in encrypted form (or, otherwise stated, the second may be or represent a respective encrypted content).

According to an alternative embodiment, the second block may be in plaintext or unencrypted form.

According to an embodiment, the second block may be in encrypted form or in unencrypted form depending on the ledger policies.

According to an embodiment, encryption of the data acknowledgement and/or of the second block may be determined by the cryptographic engine 310 of the second participant node 105₂ (e.g., under the control of the respective content manager 305).

According to an embodiment, the second block (or the corresponding data acknowledgement) is authenticated by the second participant node 105₂. According to an embodiment, the second block (or the corresponding data acknowledgement) is authenticated by a cryptographic signature of (or associated with) the second participant node 105₂.

According to an embodiment, the cryptographic signature of (or associated with) the second participant node 105₂ is performed by applying (by the second participant node 105₂) a cryptographic key of (or associated with) the second participant node 105₂ to the second block (or to the corresponding data acknowledgement).

According to an embodiment, the cryptographic key of (or associated with) the second participant node 105₂ is managed by the PKI infrastructure.

According to an embodiment, the cryptographic signature of (or associated with) the second participant node 105₂ is performed by the cryptographic engine 310 of the second participant node 105₂ (e.g., under the control of the respective content manager 305). Without losing generality, the cryptographic signature of (or associated with) the second participant node 105₂ may be performed by a dedicated signing engine of the second participant node 105₂ (not shown).

In alternative embodiments, the cryptographic signature of (or associated with) the second participant node 105₂ may be omitted (for example, when authentication of the second block, or of any block appended by the second participant node 105₂, is differently implemented).

According to an embodiment, the method 400 comprises notarizing the evolution of a history of the private ledger 110 (hereinafter, ledger history). According to an embodiment, said notarizing comprises storing corresponding digests for the ledger versions into the persistent storage (such as the public blockchain 120), wherein the digest of each ledger version is representative of the appending of the corresponding blocks of the version (action node 430).

Without losing generality, said notarization may be performed by the first participant node 105₁, by the second participant node 105₂ and/or by the certification node 115, as progressively detailed while discussing exemplary embodiments and examples.

Without losing generality, said notarization may be performed periodically (e.g., at a predetermined notarization frequency), or aperiodically (for example, upon appending of each block or upon appending of a predetermined number of blocks).

Just as a non-exhaustive example, the notarization may comprise storing (in the public blockchain 120) a digest of the ledger version being representative of the appending of the first block, and a digest of the ledger version being representative of the appending of the second block-this could be the case of, an aperiodic notarization performed upon appending of each block.

Without losing generality, the digest of the ledger version representative of the appending of the first block may be stored by the first participant node 105₁ or (as herein exemplary considered) by the certification node 115, e.g. upon (such as after or in response to) appending of the first block, and the digest of the ledger version representative of the appending of the second block may be stored by the second participant node 105₂ or (as herein exemplary considered) by the certification node 115, e.g. upon (such as after or in response to) appending of the second block. Whichever the entity performing the notarization, the digest of the ledger version representative of the appending of the first block may be computed by the first participant node 105₁ or by the certification node 115 (for example, by the respective cryptographic engine), and the digest of the ledger version representative of the appending of the second block may be computed by the second participant node 105₂ or by the certification node 115 (for example, by the respective cryptographic engine).

Just as another non-exhaustive example, the notarization may comprise storing (in the public blockchain 120) a digest of the ledger version being representative of the appending of the first and second blocks-this could be the case of, an aperiodic notarization performed upon appending of a predetermined number of blocks within which the first and second blocks fall.

Without losing generality, the digest of the ledger version representative of the appending of the first and second blocks may be stored by the first participant node 105₁, by the second participant node 105₂, or (as herein exemplary considered) by the certification node 115, e.g., upon (such as after or in response to) appending of the second block or of a last block of the predetermined number of blocks. Whichever the entity performing the notarization, the digest of the ledger version representative of the appending of the first and second blocks may be computed by the entity having appended the second block (i.e., the second participant node 105₁), by the entity having appended the last block of the predetermined number of blocks, or by the certification node 115.

Considering, just as an example, an implementation of the private ledger 110 in which each block of the private ledger 110 contains a hash value of the previous block in the appended sequence of blocks, each digest may be computed as a hash value of a (current) last block of the private ledger 110. However, digest computation may be performed differently, for example depending on the implementation of the private ledger 110.

According to an embodiment, each digest is signed by the cryptographic signature of the entity having computed and/or stored it. More generally, each digest is signed by the cryptographic signature of the entity in charge of the notarization.

According to an embodiment, each digest is signed by the cryptographic signature of the certification node 115.

According to an embodiment, action node 430 is still performed in case of non-acceptance of the data of the first block by the second participant node 105₂ (exit branch N of decision node 420). In this case, the digest(s) subsequently stored in the public blockchain 120 will be indicative of a ledger history in which no data acknowledgement is associated with the data of the first block.

Although not shown, after (or during) the appending/notarization phase, one or more corresponding information (relating to the topic) may be published by one or more among the first participant node 105₁, the second participant node 105₂, and the certification node 115 (for example on respective websites). For the purposes of the present disclosure, the published information comprises information the trustworthiness of which can be verified or proved or assessed by the data of the first block and by the corresponding data acknowledgement of the second block.

Without losing generality, the published information may comprise statements and/or declarations and/or slogans and/or claims of ethical and/or sustainable and/or virtuous behaviors/choices related to one or more aspects of the supply chain (such as food provenance, environmental and/or social impact, and presence or absence of child labor).

Reference will be now made to the auditing phase of the method 400 represented by the activity diagram of FIG. 4B.

According to an embodiment, the method 400 comprises transmitting, from the auditing node 125 (external to the private ledger 110), a verification request (action node 435).

Without losing generality, the verification request may be addressed to one or more among the first participant node 105₁, the second participant node 105₂, and the certification node 115 (as conceptually represented in the figure by dashed lines towards each one of them).

According to an embodiment, the method 400 comprises, upon reception (at the first participant node 105₁, at the second participant node 105₂, or at the certification node 115) of the verification request (action node 440), disclosing the verification information and the policies to the auditing node 125 (action node 445).

According to an embodiment, as discussed above, the verification information may comprise the last ledger version.

According to an alternative embodiment, as discussed above, the verification information may comprise the ledger portion comprising the data and the data acknowledgement (if the data acknowledgement is provided), and corresponding inclusion proofs of the ledger portion proving the inclusion of the ledger portion in the versions of the private ledger 110.

According to an embodiment, the verification information (or at least a subset thereof) may be disclosed or provided to the auditing node 125 by any entity having access to the private ledger 110 (including, but not limited to, the first participant node 105₁ and the second participant node 105₂), and/or by the certification node 115 (which may for example act as intermediate node between the auding node 125 and the first 105₁ and/or second 105₂ participant nodes).

Without losing generality, the verification information (or at least a subset thereof) may be disclosed or provided to the auditing node 125 while allowing the auditing node 125 to access the private network.

Without losing generality, the verification information (or at least a subset thereof) may be disclosed or provided to the auditing node 125 while preventing the auditing node 125 from accessing the private network.

According to an embodiment, the inclusion proofs (when provided) may be computed by any one among the first participant node 105₁, the second participant node 105₂, and the certification node 115 (for example, by means of the respective cryptographic engine, e.g., under the control of the respective content manager).

According to an embodiment, the inclusion proofs (when provided) may be computed by an entity other than the entity disclosing or providing the ledger portion and the data/acknowledgment policies.

According to an embodiment, regardless of the verification information comprises the last ledger version or a ledger portion, the verification information may further comprise the policy agreement. Without losing generality, the policy agreement may be autonomously retrieved by the auditing node 125, for example in case the policy agreement is stored separately from the private ledger 110 (and is publicly accessible).

As mentioned above, according to an embodiment, one or more among the data, the data acknowledgement, the first block, the second block, and the data/acknowledgment policies is an encrypted content. In this embodiment, regardless of the verification information comprises the last ledger version or a ledger portion, the verification information further comprises one or more decryption keys for allowing the auditing node 125 to decrypt each respective encrypted content.

According to an embodiment, the method 400 comprises, at the auditing node 125, receiving the verification information and the data/acknowledgment policies (action node 445), and receiving one or more digests from the public blockchain 120 (action node 450).

According to an embodiment, the digest(s) may be provided to the auditing node 125 by any one among the first participant node 105₁, the second participant node 105₂, and the certification node 115. According to an embodiment, the digest(s) may be provided to the auditing node 125 by an entity other than the entity disclosing or providing the verification information and the data/acknowledgment policies.

According to an embodiment, the digest(s) may be (e.g., autonomously) retrieved by the auditing node 125 from the public blockchain 120.

According to an embodiment, the method 400 comprises, at the auditing node 125, verifying (e.g., upon proper decryption, when required) the acceptance of the data by the second participant node 105₂ according to the verification information, the data/acknowledgment policies and the digests retrieved from the public blockchain 120 (action node 455). According to an embodiment, verification of the the acceptance of the data by the second participant node 105₂ according to the verification information, the data/acknowledgment policies and the digests (action node 455) is performed, at the auditing node 125, by verifying a consistency of the last ledger version or of the ledger portion and the inclusion proofs with the stored digests (hereinafter, consistency check), by verifying that the data and the data acknowledgment are included in the last ledger version or that the ledger portion satisfies the inclusion proofs (hereinafter, presence check), and verifying a compliance of the data and of the data acknowledgment with the data/acknowledgment policies (hereinafter, compliance check).

According to an embodiment, the consistency check for the last ledger version is based on a comparison between the digests of the last ledger version (e.g., computed by the auding node 125) and the digests of the last ledger version retrieved from the public blockchain 120.

According to an embodiment, the consistency check for the ledger portion and the corresponding inclusion proofs is based on a comparison of the digests of the ledger portion (e.g., computed by the auding node 125) and of the inclusion proofs with the digests retrieved from the public blockchain 120.

According to an embodiment, the presence check for the last ledger version is based on inspection (e.g., by the auding node 125) of the blocks of the last ledger version.

According to an embodiment, the presence check for the ledger portion is based on a comparison between the inclusion proofs and the digests retrieved from the public blockchain 120.

According to an embodiment, the policy check comprises determining a formal correctness of the data and of the data acknowledgment. According to an embodiment, the formal correctness of the data and of the data acknowledgement is performed (e.g., by the auding node 125) by verifying that the data and the data acknowledgment comply with the data format and the corresponding acknowledgment format, respectively, defined in the data/acknowledgment policies.

According to an embodiment, the policy check comprises assigning a meaning of the data acknowledgment according to the semantic defined in the data/acknowledgment policies.

According to an embodiment, not shown, the auditing node 125 may be configured to output an outcome of the verification request. Just as an example, in case of negative outcome due to consistency check failure, or presence check failure, or policy check failure, the auditing node 125 may be configured to output a corresponding indication of the occurred failure, whereas in case of positive outcome the auditing node 125 may be configured to output the meaning of the data acknowledgment.

Then, the method 400 ends.

### Modifications

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

An aspect of the solution according to embodiments of the present disclosure provides a method.

According to an embodiment, the method may be performed under the control of a computing system. Without losing generality, the computing system may be of any type.

According to an embodiment, the method may comprise allowing a first node and a second node of the computing system to participate to a private ledger. Without losing generality, the first and second node may be of any type. Without losing generality, the first and second nodes may be in commercial or business partnership relationship to each other.

According to an embodiment, the private ledger may be adapted to take a plurality of versions over time each resulting from appending one or more blocks thereto.

According to an embodiment, the method may comprise appending a first one of the blocks to the private ledger by the first node.

According to an embodiment, the first block is authenticated by the first node and comprises data to be shared with the second node. Without losing generality, authentication of the first block (or of the data) may be achieved by any proper proof allowing to verify that the first block (or the data) was produced and appended by the first node.

According to an embodiment, the method may comprise appending a second one of the blocks to the private ledger by the second node.

According to an embodiment, the second block comprises an acknowledgement indicative of an acceptance of the data of the first block by the second node according to one or more policies. Without losing generality, the policies may define rules or criteria defining the format of the data and the corresponding format of the data acknowledgment, such as maximum size of files and/or fields and/or strings and/or parameters, presence of optional files and/or fields and/or strings and/or parameters, presence of mandatory files and/or fields and/or strings and/or parameters, presence and/or number of signatures, signature and/or encryption criteria, and admitted and/or non admitted file types (e.g., image, pdf, ZIP file types).

Without losing generality, additional policies may be provided. Examples of additional policies comprise, but are not limited to, rules for admissions of new nodes to the private ledger and/or for interactions with or among the nodes, one or more criteria for policy update, one or more criteria for block signature and/or encryption. Without losing generality, the policies may comprise rules relating data validity and/or correct data interpretation and/or data requirement(s) fulfillment for the data associated with a corresponding acknowledgement.

According to an embodiment, the second block (or the data acknowledgment) is authenticated by the second node. Without losing generality, authentication of the second block (or of the data acknowledgement) may be achieved by any proper proof allowing to verify that the second block (or the data acknowledgement) was produced and appended by the second node.

According to an embodiment, the method may comprise storing corresponding digests for the versions of the private ledger into a persistent storage, the digest of each of the versions being representative of the appending of the corresponding blocks of the version. Without losing generality, the digests may be computed based on any proper cryptographic hash function or any other mathematical algorithm mapping data of an arbitrary size to a bit array of a fixed size.

According to an embodiment, the method may comprise disclosing verification information and the policies to an auditing node not participating to the private ledger in response to a verification request. Without losing generality, the verification information and/or the policies may be disclosed in any way (for example, over any open or protected communication channel).

According to an embodiment, the verification information may comprise a last one of the versions of the ledger.

According to an embodiment, the verification information may comprise a ledger portion comprising the data and the acknowledgement, and corresponding inclusion proofs of the ledger portion in the versions of the private ledger.

Thanks to the proposed method, the auditing node is allowed to verify the acceptance of the data by the second node according to the verification information, the policies and the digests retrieved from the persistent storage.

According to an embodiment, the auditing node is allowed to verify the acceptance of the data by the second node according to the verification information, the policies and the digests retrieved from the persistent storage by:
verifying a consistency of the last version of the ledger or of the ledger portion and the inclusion proofs with the stored digests;
verifying that the data and the acknowledgment are included in the last version of the ledger or that the ledger portion satisfies the inclusion proofs;
verifying a compliance of the data and of the acknowledgment with the policies.

Further embodiments provide additional advantageous features, which may however be omitted at all in basic implementations.

According to an embodiment, said verifying a compliance of the data and of the acknowledgment with the policies comprises determining a formal correctness of the data and of the acknowledgment by verifying that the data and the acknowledgment comply with a data format and a corresponding acknowledgment format, respectively, defined in the policies.

According to an embodiment, said verifying a compliance of the data and of the acknowledgment with the policies comprises assigning a meaning of the acknowledgment according to a semantic defined in the policies.

According to an embodiment, said storing corresponding digests is performed by a certification node of the computing system other than the first and second nodes. Without losing generality, the certification node may be of any type. Without losing generality, the digests may be computed by the certification node. Without losing generality, the appending of the first block and/or of the second block may be conditioned to an approval by the certification node: just as an example, appending requests may be transmitted to the certification node from the nodes participating to the private ledger, and corresponding appending receipts indicative of outcomes of the appending requests may be transmitted to the requesting nodes from the certification node indicative of acceptance or denial of the appending.

According to an embodiment, the digests are signed by cryptographic signatures of the certification node. Without losing generality, the cryptographic signatures of the certification node may be of any type.

According to an embodiment, the first and second blocks are authenticated by cryptographic signatures of the first and second nodes, respectively. Without losing generality, authentication of the first block and/or of the second block may be differently implemented.

According to an embodiment, the policies are contained in the private ledger. Without losing generality, the policies may be contained in a first or genesis block of the private ledger. Without losing generality, the policies may be contained or stored in local or remote storage or processing entities separate from the private ledger.

According to an embodiment, at least one among the data, the acknowledgement, the first block, the second block, and the policies is an encrypted content.

According to an embodiment, the verification information further comprises one or more decryption keys for allowing the auditing node to decrypt each respective encrypted content.

According to an embodiment, the verification information further comprises an agreement between the first and second nodes concerning the policies. Without losing generality, the agreement may further be based on and/or be conditioned to an agreement between the first and second nodes concerning the additional policies.

According to an embodiment, the agreement is contained in the private ledger. Without losing generality, the agreement may be contained in a first or genesis block of the private ledger. Without losing generality, the agreement may be contained or stored in local or remote storage or processing entities separate from the private ledger.

According to an embodiment, the persistent storage may be a tamper-proof storage.

According to an embodiment, the persistent (and tamper-proof) storage comprises a public blockchain. Without losing generality, tamper-proof features may be achieved by any technical measures (other than those based on blockchain) that substantially prevent the altering of the stored content. Without losing generality, tamper-proof features may be achieved by means of an authority that is generally trusted.

Generally, similar considerations apply if the same solution is implemented with equivalent methods (by using similar steps with the same functions of more steps or portions thereof, removing some non-essential steps or adding further optional steps); moreover, the steps may be performed in a different order, concurrently or in an interleaved way (at least in part).

Another aspect of the solution according to embodiments of the present disclosure provides a computer program configured for causing the system, i.e. each computing sub-system (such as each participant node, the certification node and the auditing node), to perform the method of above when the computer program is executed on the computing system, i.e. on each sub-system.

Another aspect of the solution according to embodiments of the present disclosure provides a computer program product.

According to an embodiment, the computer program product comprises one or more computer readable storage media having program instructions collectively stored on the readable storage media, the program instructions readable by the computing sub-system to cause the computing sub-system to perform the same method. Generally, each (software) program may be implemented as a stand-alone module, as a plug-in for a pre-existing software program (for example, a storage manager and a storage client, respectively), or even directly in the latter. It would be readily apparent that it is also possible to deploy the same solution as a service that is accessed through a network (such as in the Internet). Similar considerations apply if the program is structured in a different way, or if additional modules or functions are provided; likewise, the memory structures may be of other types, or may be replaced with equivalent participant nodes (not necessarily consisting of physical storage media). The program may take any form suitable to be used by any computing sub-system, thereby configuring the computing sub-system to perform the desired operations; particularly, the program may be in the form of external or resident software, firmware, or microcode (either in object code or in source code), for example, to be compiled or interpreted. Moreover, it is possible to provide the program on any computer readable storage medium. The storage medium is any tangible medium (different from transitory signals per se) that may retain and store instructions for use by the computing sub-system. For example, the storage medium may be of the electronic, magnetic, optical, electromagnetic, infrared, or semiconductor type; examples of such storage medium are fixed disks (where the program may be pre-loaded), removable disks, memory keys (for example, USB), and the like. The program may be downloaded to the computing sub-system from the storage medium or via a network (for example, the Internet, a wide area network and/or a local area network comprising transmission cables, optical fibers, wireless connections, network devices); one or more network adapters in the computing sub-system receive the program from the network and forward it for storage into one or more storage devices of the computing system. In any case, the solution according to embodiments of the present disclosure lends itself to be implemented even with a hardware structure (for example, by electronic circuits integrated on one or more chips of semiconductor material), or with a combination of software and hardware suitably programmed or otherwise configured.

An embodiment provides computing sub-systems (such as first and second nodes, a certification node and an auditing node) comprising means configured for performing the steps of the method of above.

According to an embodiment, each computing sub-system comprises a circuitry (i.e., any hardware suitably configured, for example, by software) for performing each step of the same method. Without losing generality, each computing sub-system may be of any type (for example, implemented by a physical machine, a virtual machine, a cloud service and so on).

Without losing generality, each computing sub-system may have a different architecture (for example, based on a global, local or wide area network, exploiting any type of wired and/or wireless connections, such as of metal wire, optical fiber, Wi-fi, mobile telephone or satellite type, and so on). However, its implementation by virtual machines running on a same physical machine is not excluded.

Generally, similar considerations apply if each computing sub-system has a different structure, comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method comprising, under the control of a computing system:
allowing a first node and a second node of the computing system to participate to a private ledger adapted to take a plurality of versions over time each resulting from appending one or more blocks thereto,
appending a first one of the blocks to the private ledger by the first node, the first block comprising data to be shared with the second node and being authenticated by the first node;
appending a second one of the blocks to the private ledger by the second node, the second block comprising an acknowledgement being indicative of an acceptance of the data of the first block by the second node according to one or more policies and being authenticated by the second node;
storing corresponding digests for the versions of the private ledger into a persistent storage, the digest of each of the versions being representative of the appending of the corresponding blocks of the version, and
disclosing verification information and the policies to an auditing node (26) not participating to the private ledger in response to a verification request, the verification information comprising:
a last one of the versions of the ledger, or
a ledger portion comprising the data and the acknowledgement, and corresponding inclusion proofs of the ledger portion in the versions of the private ledger, whereby the auditing node is allowed to verify the acceptance of the data by the second node according to the verification information, the policies and the digests retrieved from the persistent storage by:
verifying a consistency of the last version of the ledger or of the ledger portion and the inclusion proofs with the stored digests;
verifying that the data and the acknowledgment are included in the last version of the ledger or that the ledger portion satisfies the inclusion proofs;
verifying a compliance of the data and of the acknowledgment with the policies.

2. The method according to claim 1, wherein said verifying a compliance of the data and of the acknowledgment with the policies comprises:
determining a formal correctness of the data and of the acknowledgment by verifying that the data and the acknowledgment comply with a data format and a corresponding acknowledgment format, respectively, defined in the policies.

3. The method according to claim 1, wherein said verifying a compliance of the data and of the acknowledgment with the policies comprises:
assigning a meaning of the acknowledgment according to a semantic defined in the policies.

4. The method according to claim 1, wherein said storing corresponding digests is performed by a certification node of the computing system other than the first and second nodes.

5. The method according to claim 4, wherein the digests are signed by cryptographic signatures of the certification node.

6. The method according to claim 1, wherein the first and second blocks are authenticated by cryptographic signatures of the first and second nodes, respectively.

7. The method according to claim 1, wherein the policies are contained in the private ledger.

8. The method according to claim, wherein at least one among the data, the acknowledgement, the first block, the second block, and the policies is an encrypted content.

9. The method according to claim 8, wherein the verification information further comprises one or more decryption keys for allowing the auditing node to decrypt each respective encrypted content.

10. The method according to claim 1, wherein the verification information further comprises an agreement between the first and second nodes concerning the policies.

11. The method according to claim 10, wherein the agreement is contained in the private ledger.

12. The method according to claim 1, wherein the persistent storage comprises a public blockchain.

13. (canceled)

14. A computer program product comprising one or more computer readable storage media having program instructions collectively stored on the readable storage media, the program instructions being readable by a computing system to cause the computing system to perform the method according to claim 1.

15. A computing system comprising circuitry configured for performing the method according to claim 1.
